(19) United States
(12) Patent Application Publication
(10) Pub. No.: US 2020/0269981 A1
(43) Pub. Date: Aug. 27, 2020

(54) AIRCRAFT EXTERNAL TANK FOR FIREFIGHTING USE

(71) Applicant: E.D.U Aerospace Ltd., Kidron (IL)

(72) Inventor: Tsuri Minerbi, Kidron (IL)

(73) Assignee: E.D.U Aerospace Ltd., Kidron (IL)

(21) Appl. No.: 16/796,360

(22) Filed: Feb. 20, 2020

Related U.S. Application Data
(60) Provisional application No. 62/808,607, filed on Feb. 21, 2019.

(51) Int. Cl. B64D 1/16; A62C 3/02

(52) U.S. Cl. CPC B64D 1/16; A62C 3/0235

(57) ABSTRACT

An external aircraft tank configured for attachment to an aircraft via a pylon that serves both to mechanically support the tank and to convey electrical power and control signals to the tank. The tank has an opening in a lower surface thereof, a releasable shutter configured to cover the opening, and an actuator articulated to the shutter and responsive to a switching signal conveyed from the aircraft for moving the shutter from the closed position to an open position whereby fire suppressant stored in the tank is released through the opening.

### TECHNICAL FIELD

The present disclosure relates to firefighting in general, and to aircraft firefighting, in particular.

### BACKGROUND

In the last several decades, the world has faced an increasing number of fire disasters. California's latest disaster caused devastating results: Camp Fire, which began Nov. 8, 2018; caused 86 deaths and destroyed 18,804 structures. Woolsey Fire, which broke out on the same day as the Camp Fire, resulted in three deaths and the destruction of 1,643 structures. A shortage of appropriate equipment for handling mega size fires was recorded.

The use of aircraft and other aerial resources to combat wildfires has been proven to be efficient especially in extensive fires. The types of aircraft used include fixed-wing aircraft and helicopters.

It is well known that military aircraft are equipped with external fuel tanks that contain reserve fuel, which may be supplied to the main fuel supply system controlled by the pilot, in order to extend flight range. Such tanks are supported from the aircraft wing by a pylon through which electrical power and control signals may be sent to an electronics circuit located inside the tanks and which also connects the tank to the fuel supply system. For example, in the case of F-16 aircraft, external fuel tanks feed into the wing main tanks.

Reference is also made to https://commons.wikimedia.org/wiki/Category:Drop_tanks, which shows detailed images of external fuel tanks for various types of aircraft.

Although external fuel tanks were developed for military aircraft in order to increase range and reduce the demand for tanker support, it has also been proposed to use similar techniques for civilian purposes, particularly for fire-fighting for the same purpose of extending range.

U.S. Pat. No. 5,549,259 discloses methods relating to the conversion and operation of aircraft as air tankers equipped with baffled liquid storage tanks; high velocity-high volume liquid discharge systems for fighting fires from aircraft and particularly to delivering fire retardant or water for the suppression of fires.

US20060108476 discloses a system and method for enhancing fuel stores volume of an aircraft in order to extend its flight range. The aircraft may be a fighter aircraft such as an F-16. An external fuel tank is suspended on a carrier pylon uploaded on an outboard wing. The pylon is capable of transferring fuel from an external fuel container to the aircraft fuel system and of transmitting, and controlling the fuel store in the auxiliary fuel container attached to the pylon.

Here also the objective is to extend the range i.e. the distance that the aircraft can fly without needing to land in order to refuel. Among various uses of the described method and system is fire-fighting. However, there is no suggestion to use the external tanks to store fire suppressant.

US20190375505 discloses detachable pilotable capsules intended for forest fire fighting and other rescue missions.

### SUMMARY OF THE INVENTION

It is an object of the invention to facilitate the use of external fuel tanks of the kind described for storing and releasing fire suppressant.

This object is realized in accordance with an embodiment of the invention by an external aircraft tank configured for attachment to an aircraft via a pylon that serves both to mechanically support the tank and to convey electrical power and control signals to the tank, the tank being provided in a distal surface thereof with an opening sealed by a releasable shutter that is responsive to a switching signal conveyed from the aircraft for moving from a closed position to an open position whereby fire suppressant stored in the tank is released through the opening.

Thus according to the invention external tanks, such as drop tanks, wing tanks, belly tank, or the like, are configured to store fuel for the aircraft. This may be done by manufacturing tanks that are adapted to store fire suppressant and which may be released from the tank's opening via a suitable switching signal. Alternatively, existing external tanks may be retro-fitted and used for storing fire suppressant instead of fuel. As a result, existing external fuel tanks of aircraft may be converted into firefighting tanks. The fire-suppressant may include water, water enhancers such as foams and gels, specially formulated fire retardants such as Phos-Chek, and the like.

The adaptation of the existing external tanks may be applicable for all types of aircraft, such as fixed wings, helicopters, or the like. The disclosed subject matter may be relevant to all kinds of aircraft with current or future external fuel tanks, such as transport aircraft, fighters, helicopters, or the like. Aircraft with external fuel tanks may be, but not limited, to: C-130, F-16, F-15, F/A-18, F-4, Rafale, Gripen, Mirage, Blackhawk, CH-53 & C-130 and others. Such aircraft may be equipped with external tanks with a high capacity comparable with regular firefighting aircraft. For example, the capacity may exceed 10,000 liters of fluid.

In some exemplary embodiments, the external fuel tank may be replaced with a new external tank that is configured to store firefighting fluid. The new external tank may have similar shape and properties as the external tank, but may be configured to release fire extinguishing material during flight from an opening thereof. Additionally or alternatively, existing external fuel tanks may be adapted or retrofitted by removing the fuel supply lines and other redundant features and adding openings, to enable filling and releasing fire suppressant therefrom. The same outer geometrical, inertia and weight characteristics of the already existing in use external tanks may be utilized for the firefighting external tanks. As a result, additional expensive flight tests to validate the shape and properties of the external tanks for flight, may be avoided. Automatic mechanical opening systems may be added to the existing external tanks, in order to enable control thereof.

In some exemplary embodiments, aircraft external tanks engineering characteristics, such as weight, inertia characteristics and outer dimensions, or the like, may be kept or adapted for the external tanks. Two opening doors and automatic opening system may be installed in order to provide for fast release of fire-retardant liquid. The majority of the capacity of the external tank may be utilized for storing fire retardant liquid.

In some exemplary embodiments, the fire extinguishing material may be released from the external tank upon a command from a pilot of the aircraft. The pilot may control opening and closing of the external tank doors, by using a button that is electrically coupled to the automatic opening system or by wireless communication therewith. The pilot may control the volume of the extinguishing material being dropped.

In some exemplary embodiments, existing (e.g. used) external fuel tanks may be modified from their current design in order to be adapted for firefighting. Current components which are installed in the existing external fuel tanks may be removed. In some exemplary embodiments, the Outer Mold Line (OML) of the external tanks may be preserved, in order to maintain the aero shell's outer surface of the aircraft and enable the accurate flight thereof. In some exemplary embodiments, the new design of the firefighting tanks may comprise one or more openings (e.g., doors) and actuators. The doors may be opened and closed by actuators located inside the firefighting tanks. Opening the doors may be commanded by the pilot, which will have a specific control button in the cockpit. When the doors open, the retardant liquid may start flowing out of the firefighting tanks. Additionally or alternatively, the OML of the external tanks may remain unchanged when the doors are opened. For example, the doors may be opened by being pulled into the internal volume of the external tanks. A short while after the retardant has been fully expelled, the doors may close either automatically or by the pilot command.

In some exemplary embodiments, the firefighting tanks may be mounted to the same existing pylons of the regular external tanks, and may be configured to use the same bolts thereof. Additionally or alternatively, the pylon of the aircraft may be modified to enable the electrical connection from the cockpit to the firefighting tanks to allow the command for opening the doors.

One benefit of the invention is to provide efficient firefighting using existing equipment. By utilizing the disclosed subject matter, the additional expensive flight tests required for providing new firefighting aircrafts may be avoided owing to the use of the same outer geometrical and weight characteristics of the already existing in use external tanks. Additionally or alternatively, utilizing removable external tanks may be efficient for fast refilling and replacement of external tanks. The use of internal water tanks may not always be efficient as the aircraft may be shut down during the refilling of the tanks. Additionally or alternatively, the use of existing aircraft may be enabled, and there may be no need for having a specialized firefighting squadron. Instead, existing squadrons having other tasks, such as combat tasks, transportation tasks, or the like, may be adapted, on-demand, to perform firefighting tasks.

Another benefit of the invention is to enable vital firefighting factors, such as fast arrival to the fire zone and massive fire-retardant release. The existing aircraft, such as fighter aircraft, may be fast flying and may have a large capacity in their external comparing with existing firefighting aircrafts. Such fighter aircrafts may be adapted to perform the firefighting tasks in relatively short time, with relatively little effort.

Yet another benefit of the invention is to enable an around the clock all week [24/7] firefighting operation. Operation of some existing firefighting aircraft may be limited only to day time hours. Utilizing existing aircraft, military aircraft in particular, may enable accurate operation of the firefighting, even at night.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a pictorial plan view of an aircraft showing a pair of external tanks supported by the wings on opposite sides of the fuselage;

FIG. 2 is a pictorial representation showing an end elevation of one of the external tanks;

FIG. 3 is a pictorial representation of an external tank according to an embodiment of the invention having an opening shut by a pair of slidable shutters;

FIG. 4 is a pictorial representation of the external tank depicted in FIG. 3 with the shutters in an open position;

FIG. 5 is a pictorial representation of an external tank of the kind deployed by an F-16 fighter aircraft but constructed or modified according to the invention;

FIG. 6 is a pictorial representation showing the internal structure of the external tank according to an embodiment of the invention; and

FIGS. 7a and 7b are schematic representations of an actuator for opening and closing the shutters of an external tank according to an embodiment of the invention.

### DETAILED DESCRIPTION

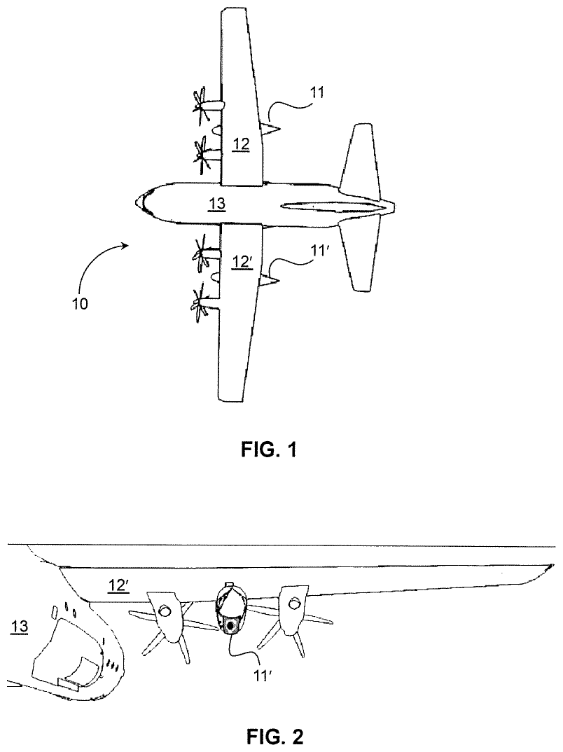

FIG. 1 is a pictorial plan view of an aircraft 10 showing a pair of external tanks 11, 11′ supported by the wings 12, 12′ on opposite sides of the fuselage 13. FIG. 2 shows an end elevation of one of the external tanks 11′. Each external tank 11, 11′ is customized for use with a specific type of aircraft and is shaped and dimensioned so as to match the aerodynamic footprint of external fuel tanks that are authorized for use with the same type of aircraft. This avoids the need to check the lift and drag characteristics of the tank and ensures that it meets the requisite standards for the intended aircraft. The external tanks 11, 11′ according to the invention are ideally deployed by fighter aircraft, partly because they can then be fitted to the aircraft instead of conventional external reserve fuel tanks without the need to modify the aircraft; and also because fighter aircraft can fly faster than civilian aircraft and therefore be deployed more quickly.

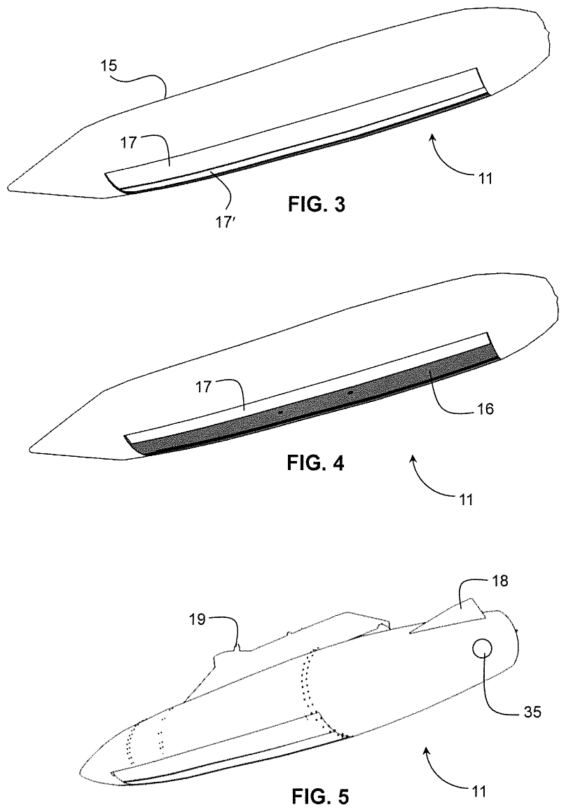

As seen in FIG. 3, the external tank 11 has a body portion 15 whose outer shell is preferably of identical size and shape to a known external fuel tank that is authorized for use with a specific aircraft. Companies that manufacture external fuel tanks for fighter aircraft need approval by the aircraft manufacturer. The same companies may be engaged to manufacture the external tanks according to the invention or retrofit existing tanks that were initially used or intended for use as reserve fuel tanks since they already have the capability to produce external tanks of the correct size and shape that are adapted for support by pylons mounted under the wings of the designated aircraft through which electrical power and control may be directed to components inside the tank. Custom manufacture avoids the need to disassemble and retrofit an existing fuel tank and results in lower cost.

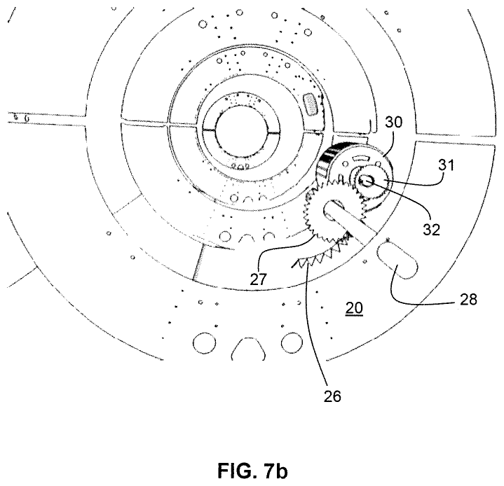

In one embodiment, the tank is provided with an elongated opening 16 that is shut by a pair of slidable shutters 17, 17′ shown in FIG. 3 in the closed position and in FIG. 4 in the open position. The shutters 17, 17′ slide within internal tracks (not shown) so that in the closed position shown in FIG. 3 they conform to the outer contour of the outer shell of the body portion 15. In the open position, the shutters 17, 17′ are fully retracted inside the body portion so as to release fire suppressant previously stored therein. Seals (not shown) are provided to ensure that when closed, fire suppressant cannot leak out of the tank. The shutters 17, 17′ are adapted to be opened and closed by an actuator such as described in more detail below with reference to FIGS. 7a and 7b of the drawings.

FIG. 5 shows pictorially an external tank 11 of the kind deployed by an F-16 fighter aircraft but constructed or modified according to the invention. Shown in the figure is a tail fin 18 that improves aerodynamic performance and the support flange 19 by means of which the tank is coupled to the pylon.

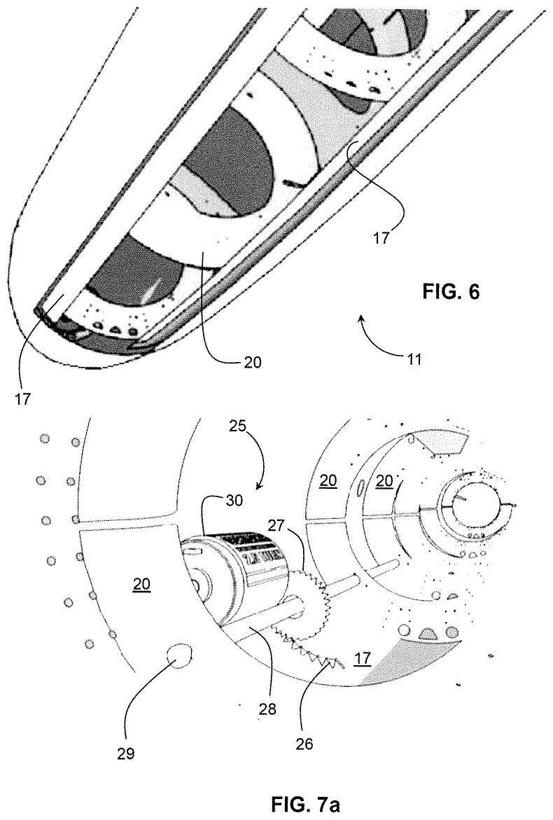

FIG. 6 shows pictorially the internal structure of the external tank 11 having axially displaced reinforcement ribs 20 that are welded to the internal surface of the body portion, while leaving a slight gap of sufficient clearance to accommodate the sliding shutters. Alternatively, instead of a single opening, multiple openings can be formed each between an adjacent pair of reinforcement ribs 20 and each articulated to its own actuator or all being articulated to a single actuator.

In order that the tank 11 will cause minimal disruption to or deterioration of the aerodynamic properties of the aircraft, it may be desirable that the tank 11 have the same OML as the original external fuel tanks of the associated aircraft. However, it will also be understood that the OML of external fuel tanks is designed to reduce the radar signature of the aircraft and this is obviously not an important consideration when the aircraft is used for firefighting missions. In the embodiment described above with reference to FIGS. 3 and 4 this is achieved by constructing the shutters 17, 17′ with the same contour as the outer shell of the tank and by opening with a sliding movement into an internal pocket. But the invention also contemplates other configurations such as hinged shutters that open by being pushed downwards to, even though this would change the OML. The aircraft external tank 11, 11′ is filled with fire retardant liquid, and may be configured to retain the aircraft's flight envelopes of the original fuel tanks.

FIGS. 7a and 7b show schematically an embodiment of an actuator shown generally as 25 for opening and closing the sliding shutters 17, 17′ of the tank. As noted above, the shutters are configured for sliding motion within an internal recess of the tank and for the sake of explanation the actuator 25 will be described with reference to only a single shutter 17. An arcuate geared track 26 is welded or otherwise attached to an internal surface of the shutter parallel to its circumference such that an imaginary plane through the track 26 is normal to a longitudinal axis of the tank. A gear wheel 27 in meshing engagement with the track 26 is fixedly mounted on a shaft 28 that is supported by the reinforcement ribs 20 and extends through apertures 29 formed therein. The gear wheel 27 is driven by an electric motor 30 having a gear wheel 31 mounted on its shaft 32. The motor 30 may be operated by a DC voltage applied via a power cable that extends from the aircraft through the pylon to the tank 11. In this case, DC voltage of a first polarity will close the shutter 17 and DC voltage of a second, opposite polarity will open the shutter. Alternatively, an AC induction motor can be used and the direction changed by changing the direction of the magnetic field applies to the stator. The ability to both open and close the shutters allows the shutters to be re-closed after the fire suppressant is completely discharged, either automatically or manually, so as to restore the OML of the tank.

It will be appreciated that the actuator 25 is shown schematically and that other types of actuators may be employed such as solenoid, hydraulic or pneumatic. Likewise, the shaft 28 may support multiple gear wheels, each in meshing engagement with the respective track of a different shutter so that multiple shutters can be actuated simultaneously by applying a switching signal to the motor.

It should be understood that while use of a motorized actuator as described allows both opening and closing of the shutter, an alternative arrangement is for the shutter to be biased into a closed position by a spring and to be opened by applying a switching signal to the actuator.

Prior to deployment, the shutters are moved to their closed position and the tank 11 is filled with fire suppressant via a supply aperture shown as 35 in FIG. 5. The supply aperture 35 may be coupled to a one-way valve (not shown) inside the tank to prevent escape of gaseous fire suppressant. The tanks are then mounted on the aircraft pylons in known manner, whereby the electrical power and control connections to the actuator 25 inside the tank are automatically effected.

The above description is directed to one skilled in the relevant, art, typically a manufacturer of external fuel tanks such as Elbit Systems Cyclone Ltd., a subsidiary of Elbit Systems Ltd., which is a licensed manufacturer of structural aircraft components as well as parts for leading aerospace companies and OEMs. External fuel tanks produced by such companies contain fuel supply lines and internal valves that are operated from within the cockpit. To this end, electrical power and control signals are fed to the tank via the pylons and the same connections are used to power and control the actuator of the present invention. Likewise, the same control button used by the pilot to open and close the valves of the external fuel tank, when installed, may be used to control the actuator of the invention. It will be appreciated, however, that the switching signal may alternatively be conveyed wirelessly to the actuator.

The description of the above embodiments is not intended to be limiting, the scope of protection being provided only by the appended claims. In particular, it should be noted that features that are described with reference to one or more embodiments are described by way of example rather than by way of limitation to those embodiments. Thus, unless stated otherwise or unless particular combinations are clearly inadmissible, optional features that are described with reference to only some embodiments are assumed to be likewise applicable to all other embodiments also.

While the invention has been described with particular regard to external tanks containing releasable fire suppressant for use with military aircraft, the same principles may be applied for use with civilian aircraft and also for rotary wing aircraft, both military and civil. Furthermore, when used for civilian aircraft some of the harsh requirements relating to aerodynamic shape and other properties may be somewhat relaxed, since speed is lower and the need to minimize radar signature is clearly less critical, if at all.

Finally, the term “pylon” as used herein and in the appended claims is intended to embrace any support that allows the external tank to be mechanically supported and that allows electrical power and control signals to be conveyed from the aircraft to the tank. Although generally the pylon is a uniform structure that facilitates both of these purposes, it may be distributed so that the electrical connections are conveyed through a conduit that is separate from the mechanical support structure.

1. An external aircraft tank configured for attachment to an aircraft via a pylon that serves both to mechanically support the tank and to convey electrical power and control signals to the tank, the tank comprising:
an opening in a lower surface thereof,
a releasable shutter configured to cover the opening, and
an actuator articulated to the shutter and responsive to a switching signal conveyed from the aircraft for moving the shutter from the closed position to an open position whereby fire suppressant stored in the tank is released through the opening.

2. The tank according to claim 1, wherein the shutter includes one or more doors arranged for sliding on an internal surface of the tank.

3. The tank according to claim 1, wherein the shutter includes one or more doors attached by hinges to a respective edge of the opening and being responsive to the switching signal for swinging open.

4. The tank according to claim 1, wherein the releasable shutter is biased into the closed position before operation of the actuator.

5. The tank according to claim 4, wherein:
at least one spring is coupled to the shutter for applying a biasing force to maintain the shutter into the closed position, and
the actuator is configured to overcome the biasing force of the spring.

6. The tank according to claim 4, wherein the actuator is responsive to electrical power conveyed thereto for moving the shutter into the closed position.

7. The tank according to claim 6, wherein the actuator is configured to open the shutter upon interruption of electrical power.

8. The tank according to claim 2, wherein the actuator is configured to close the shutter upon application of electrical power of a first polarity and to open the shutter upon application of electrical power of an opposite polarity.

9. The tank according to claim 8, wherein the actuator includes a motor that operates a gear wheel in meshing engagement with a gear track supported on an internal surface of the shutter.

10. The tank according to claim 1, comprising a shell having an Outer Mold Line (OML) that conforms to that of an external fuel tank authorized for transport by the aircraft.

11. The tank according to claim 1, being a retrofitted fuel tank whose Outer Mold Line (OML) is unchanged during its conversion for releasable storage of fire suppressant.

12. The tank according to claim 1, wherein the actuator is responsive to discharge of fire suppressant for closing the shutter.

13. An external aircraft tank configured for attachment to an aircraft via a pylon that serves to mechanically support the tank comprising:
an opening in a lower surface thereof,
a releasable shutter configured to cover the opening, and
an actuator energized by electrical power and articulated to the shutter and responsive to a switching signal conveyed from the aircraft for moving the shutter from the closed position to an open position whereby fire suppressant stored in the tank is released through the opening.

14. The tank according to claim 13, wherein the shutter includes one or more doors arranged for sliding on an internal surface of the tank.

15. The tank according to claim 13, wherein the actuator is configured to open the shutter upon interruption of electrical power.

16. The tank according to claim 13, wherein the actuator includes a motor that operates a gear wheel in meshing engagement with a gear track supported on an internal surface of the shutter.

17. The tank according to claim 13, wherein the actuator includes a motor that operates a gear wheel in meshing engagement with a gear track supported on an internal surface of the shutter.

18. The tank according to claim 13, comprising a shell having an Outer Mold Line (OML) that conforms to that of an external fuel tank authorized for transport by the aircraft.

19. The tank according to claim 13, being a retrofitted fuel tank whose Outer Mold Line (OML) is unchanged during its conversion for releasable storage of fire suppressant.

20. The tank according to claim 13, wherein the actuator is responsive to discharge of fire suppressant for closing the shutter.
